(19) United States
(12) Patent Application Publication
(10) Pub. No.: US 2013/0146371 A1
(43) Pub. Date: Jun. 13, 2013

(54) REAL-TIME WEIGHING DEVICE FOR USE WITH HOSPITAL BED

(71) Applicant: PAO MING SHIH, TAIPEI CITY (TW)

(72) Inventor: PAO MING SHIH, TAIPEI CITY (TW)

(73) Assignee: CAREMED SUPPLY INC., NEW TAIPEI CITY (TW)

(21) Appl. No.: 13/314,425

(22) Filed: Dec. 8, 2011

(51) Int. Cl. G01G 19/52

(52) U.S. Cl. 177/144

(57) ABSTRACT

A real-time weighing device for use with hospital bed includes a bed frame; a support plate spread on a top of the bed frame and made of a light but rigid enough material; a plurality of load cells uniformly distributed between the bed frame and the support plate for measuring a weight value of a patient lying on the support plate; and a processing element electrically connected to the load cells for collecting, sorting and calculating values of weight measured by the load cells to derive data about the patient's body weight and the patient's current center of gravity on the support plate, so that the derived data may provide nursing personnel with more complete data about the patient's current state.

### FIELD OF THE INVENTION

The present invention relates to a weighing device for use with hospital bed, and more particularly to a real-time weighing device for use with hospital bed to synchronously measure a patient's weight and monitor the patient's movement on the hospital bed.

### BACKGROUND OF THE INVENTION

It is very difficult to measure a patient's weight when the patient lying on a hospital bed can not move on bed by himself or herself due to illness or injury. To enable weighing a bedridden patient conveniently, there are various types of weighing devices develop and introduced into the market. For example, U.S. Pat. No. 5,086,856 discloses a weighing structure including a plurality of weighing devices, which are configured and arranged corresponding to wheels of a hospital bed. To use the weighing structure, the portable weighing devices are separately placed below the wheels of the hospital bed to weigh the loads on the weighing devices. The measured loads on the weighing devices are summed to obtain the patient's body weight without the need of moving the patient.

While the weighing structure disclosed in U.S. Pat. No. 5,086,856 can be effectively used to measure the patient's body weight without the need of moving the patient, it does not provide a function of monitoring the patient in real time. However, for a patient suffering from some special disease, the nurse has to know not only the patient's body weight, but also whether the patient keeps the same lying position on the hospital bed, so as to prevent the patient from getting out of bed without being accompanied by the nurse or carelessly falling off the bed. The conventional weighing structure for use with hospital bed apparently fails to satisfy the requirements of monitoring a patient lying on the bed and helping a nurse in protecting the patient against undesirable moving on or falling off the bed. It is therefore necessary to develop an improved weighing device for use with hospital bed.

### SUMMARY OF THE INVENTION

A primary object of the present invention is to provide a real-time weighing device for use with hospital bed, so as to measure a bedridden patient's weight without the need of moving the patient while monitor the patient's movements on the hospital bed. Therefore, it is able to timely prevent the patient from getting out of bed without being accompanied by a nurse or carelessly falling off the hospital bed.

To achieve the above and other objects, the real-time weighing device for use with hospital bed according to a preferred embodiment of the present invention includes a bed frame; a support plate made of a light but rigid enough material and spread on a top of the bed frame; a plurality of load cells uniformly distributed between the bed frame and the support plate for measuring a weight value of a patient lying on the support plate; and a processing element electrically connected to the load cells for collecting, sorting and calculating values of weight measured by the load cells to derive data about the patient's body weight and the patient's current center of gravity on the support plate.

In another preferred embodiment, the load cells respectively include a supporting unit and a strain measurement unit; and the strain measurement unit is correspondingly associated with the supporting unit for measuring any strain of the supporting unit under pressure.

In a further preferred embodiment, the load cells are uniformly arranged at four corners of the bed frame.

In a still further preferred embodiment, the load cells respectively include a supporting unit and a strain measurement unit; and the strain measurement unit is provided on a surface of the supporting unit for measuring any strain of the supporting unit under pressure.

In another preferred embodiment, the supporting unit is configured as a square beam having an end locked to an edge of the bed frame and another opposite end extended beyond an outer side of the bed frame to suspend in air; and includes a height-adjusting bolt provided at the end of the supporting unit extended beyond the outer side of the bed frame to suspend in air.

The present invention is characterized in a real-time weighing device for use with hospital bed, which includes a bed frame; a support plate spread on a top of the bed frame and made of a light but rigid enough material; a plurality of load cells uniformly distributed between the bed frame and the support plate for measuring a load on the support plate; and a processing element electrically connected to the load cells for collecting, sorting and calculating weight signals transmitted from the load cells to derive in real time the patient's body weight and the patient's current center of gravity on the support plate, so as to provide nursing personnel with more complete data about the patient's current condition.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a real-time weighing device for use with hospital bed according to a preferred embodiment of the present invention;

FIG. 2 is a block diagram showing the wiring of the real-time weighing device for use with hospital bed according to the present invention;

FIG. 3 is an enlarged view showing a load cell included in the real-time weighing device of the present invention; and

FIG. 4 is a plan view schematically indicating a patient's position on a hospital bed derived with the real-time weighing device of the present invention.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

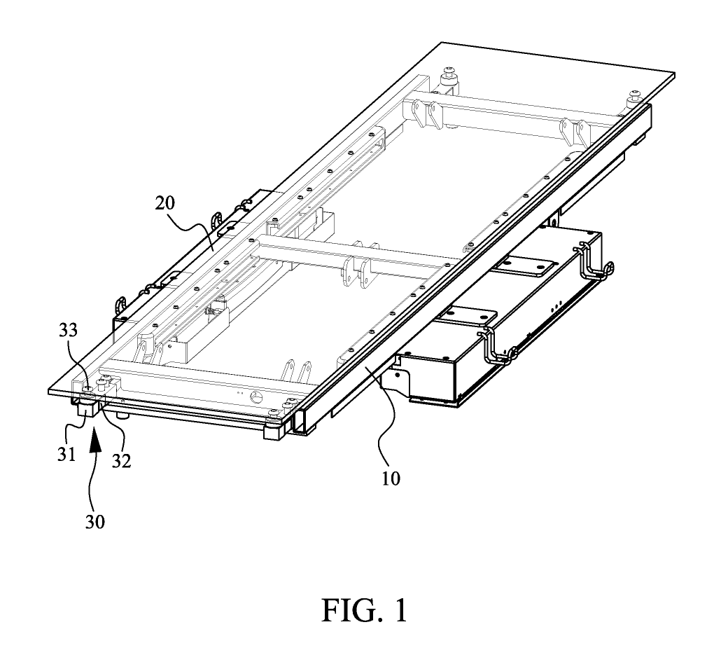

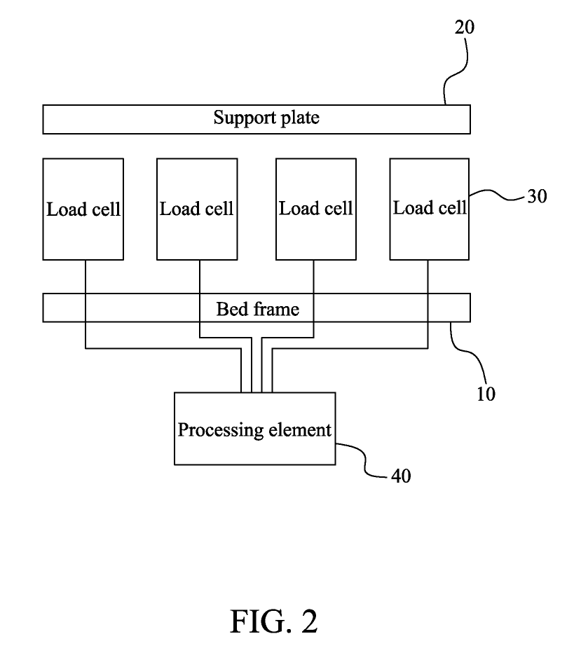

Please refer to FIG. 1 that is a perspective view of a real-time weighing device for use with hospital bed according to a preferred embodiment of the present invention, and to FIG. 2 that is a block diagram showing the wiring of the real-time weighing device. As shown, the real-time weighing device for use with hospital bed includes a bed frame 10, which can be of any configuration and structure completely according to actual need in use without particular restriction thereto; a support plate 20 spread on a top of the bed frame 10 and made of a light but rigid enough material; a plurality of load cells 30 uniformly distributed between the bed frame 10 and support plate 20 for measuring the weight of the support plate and a patient lying thereon; and a processing element 40 electrically connected to the load cells 30 for collecting, sorting, and calculating weight signals from the load cells 30. In an operable embodiment, the load cells 30 are arranged at four corners of the bed frame 10 to increase the distances between the load cells 30 and the patient's center of gravity, so as to provide improved measuring accuracy.

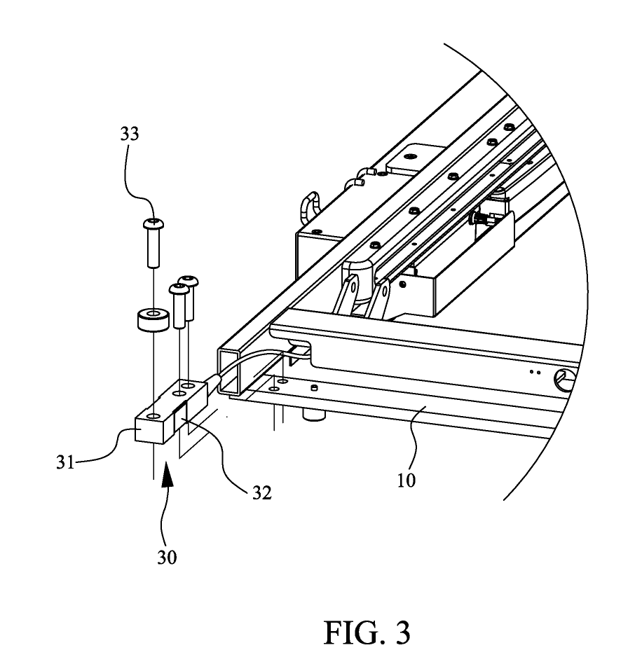

FIG. 3 is an enlarged view of the load cell 30. Please refer to FIG. 3 along with FIG. 1. In the illustrated preferred embodiment, the load cells 30 respectively include a supporting unit 31 configured as a square beam, and a strain measurement unit 32 attached to one surface of the supporting unit 31. The supporting unit 31 has an end locked to an edge of the bed frame 10 and another opposite end extended beyond an outer side of the bed frame 10 to suspend in air. To avoid the measuring accuracy from being adversely affected by gaps existing at different contact points between the supporting units 31 and the support plate 20, a height-adjusting bolt 33 is further provided on the end of each of the supporting units 31 extended beyond the bed frame 10, so as to ensure exact contact between each supporting unit 31 and the support plate 20. The strain measurement unit 32 is attached to a middle section of the supporting unit 31 for measuring an extent of strain elongation of the supporting unit 31 under pressure. From the measured strain elongation, the weight bearing by the supporting unit 31 can be derived.

The configuration of the load cells 30 and the manner in which the load cells 30 are associated with the bed frame 10 as mentioned above are only exemplary to facilitate easy explanation of the present invention and not intended to restrict the present invention in any way. For example, the supporting units 31 of the load cells 30 can be configured as cylindrical body, S-shaped body or the like, depending on actual need in use.

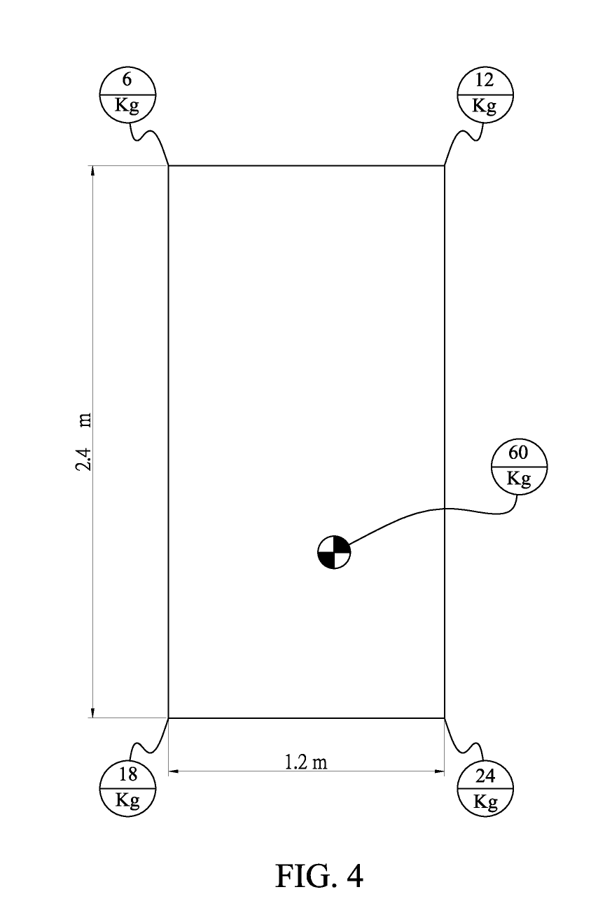

Please refer to FIG. 4 that is a plan view schematically indicating a patient's position on the support plate 20 derived with the real-time weighing device of the present invention. When a patient is lying on the support plate 20, the patient's body weight will distribute via the support plate 20 to the load cells 30 provided between the support plate 20 and the bed frame 10. Since the support plate 20 is made of a light but rigid enough material, the weight distributed to each of the load cells 30 varies with the distance between the load cell 30 and the patient's center of gravity as well as the position of the load cell 30 relative to the support plate 20. That is, the weight bearing by each of the load cells 30 is in relation to the patient's body weight and the patient's lying position on the support plate 20.

On receipt of values of weight measured by and at the load cells 30, the processing element 40 first sorts and calculates the measured values of weight as well as the arranged positions of the load cells 30, and then uses interpolation to derive the patient's lying position on the support plate 20. For instance, when the bed frame 10 has a length of 2.4 meters and a width of 1.2 meters, and the values of weight measured by the load cells 30 located at four corners of the bed frame 10 are 6 kgs, 12 kgs, 18 kgs and 24 kgs, it is derived the patient's center of gravity is currently located at a point on the support plate 20 about 72 cms from a lower left corner of the bed frame 10 in both transverse and longitudinal directions of the hospital bed, and the patient's body weight is 60 kgs.

In the case the processing element 40 is set to periodically collect, sort and calculate the newest values of weight measured by the load cells 30, it is possible to obtain dynamic data about the patient's lying positions. With the dynamic data, it is able to analyze changes in the patient's weight condition (i.e. weight gain or loss) and monitor the patient's movement on the hospital bed. In the event the data derived from the values of weight measured by the load cells 30 in real time indicates the patient intends to get out of bed or shows any other unnatural movement, a nurse can be immediately warned of such condition.

In summary, the real-time weighing device for use with hospital bed according to the present invention includes a bed frame; a support plate spread on a top of the bed frame and made of a light but rigid enough material; a plurality of load cells uniformly distributed between the bed frame and the support plate for measuring a load on the support plate; and a processing element electrically connected to the load cells for collecting, sorting and calculating weight signals transmitted from the load cells to derive in real time the patient's body weight and the patient's current center of gravity on the support plate, so as to provide nursing personnel with more complete data about the patient's current condition.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A real-time weighing device for use with hospital bed, comprising:
a bed frame;
a support plate being made of a light but rigid enough material and spread on a top of the bed frame;
a plurality of load cells being uniformly distributed between the bed frame and the support plate for measuring a weight value of a patient lying on the support plate; and
a processing element electrically connected to the load cells for collecting, sorting and calculating signals transmitted from the load cells.

2. The real-time weighing device for use with hospital bed as claimed in claim 1, wherein the load cells are arranged at four corners of the bed frame.

3. The real-time weighing device for use with hospital bed as claimed in claim 1, wherein each of the load cells includes a supporting unit and a strain measurement unit; and the strain measurement unit being provided on a surface of the supporting unit for measuring any strain of the supporting unit under pressure.

4. The real-time weighing device for use with hospital bed as claimed in claim 3, wherein the supporting unit is configured as a square beam having an end locked to an edge of the bed frame and another opposite end extended beyond an outer side of the bed frame to suspend in air; and includes a height-adjusting bolt provided at the end of the supporting unit extended beyond the outer side of the bed frame to suspend in air.
